(19) United States
(12) Patent Application Publication
(10) Pub. No.: US 2011/0176701 A1
(43) Pub. Date: Jul. 21, 2011

(54) Autoaugmented Speaker Port

(76) Inventor: William E. Collins, Swansea, IL (US)

(21) Appl. No.: 12/688,873

(22) Filed: Jan. 16, 2010

(51) Int. Cl. H04R 1/02

(52) U.S. Cl. 381/386

(57) ABSTRACT

A compact high acoustic power loudspeaker system includes an enclosure in which at least one low frequency speaker device and a bass-reflex port are provided. The bass-reflex port is mounted on the enclosure in a semiflexible manner such that the port can vibrate to provide additional bass reinforcement as compared to prior art loudspeakers. The bass-reflex port broadens the frequency response of the port and is less subject to “one-note bass” as compared to prior art ported systems.

### BACKGROUND OF THE INVENTION

1. Field of the Invention

The present invention relates to an autoaugmented bass-reflex port that provides increased sound pressure levels across a broader frequency range. The port is suspended in an aperture in a wall of a loudspeaker enclosure in a manner than the port can vibrate reducing air turbulence within the port with a comparative improvement in low frequency response.

2. Brief Description of the Prior Art

Loudspeaker systems capable of generating large power outputs have been developed using various configurations. When large output power is to be achieved with small enclosures, radiation from the back of the cones of small speakers often becomes a source of distortion; accordingly absorbent materials are employed to reduce this effect. The absorbent material, however, alters the frequency response of the speaker system, usually attenuating the response at low frequencies excessively.

Techniques have been proposed to improve the low frequency response and efficiency of a small speaker system. As a result, vented loudspeaker systems have become popular. The two common techniques to realize vented loudspeaker systems are the ducted port and passive radiator. In one technique, such as described by Schott, a bass-reflex speaker enclosure is depicted with a ducted port to reduce low frequency distortion. The port in these prior systems acoustically loads the loudspeaker cone at low frequencies and reduces distortion. The output of the port can approach that of the cone in a tradeoff between bass power and extension. The effect of the bass-reflex port is based on the Helmholtz resonator principle, which is known per se, the frequency of the reproduced sound being dependent on the volume of the enclosure, the length and cross-section of the port and the velocity of sound. Small loudspeaker enclosures require a port of comparatively small cross-section. The acoustic mass of air in the enclosure vibrates at the Helmholtz frequency, or port-tuning frequency. However, in order to obtain the same sound pressure at or near the Helmholtz frequency in a small enclosure as in a large enclosure, it is necessary that, per unit of time, the same amount of air flows through the port. Consequently the flow velocity of the air in the port is comparatively high for a small enclosure. It has been observed that at high sound levels at or near the Helmholtz frequency, bass-reflex ports of constant cross-section experience sound distortion due to air turbulence. The port output decouples from the speaker at these levels and induces noise and acoustic losses, particularly for small port cross-sections. Often a simple increase in port cross-section solves these problems, but can produce others, such as inconveniently large enclosures and excessive midrange output. Instead of ports with larger cross-sections, flared ports can be used to decrease port nonlinearity with some success. Thus flared ports decrease port cross-section, reduce port turbulence and improve low frequency performance in modest enclosures. These complicated ports and embodiments can still suffer from diminished port output at high sound pressure levels. Means to increase coupling the port output with the speaker diminish the undesired organ pipe resonance previously indicated.

Tuned baffles can be used inside ported loudspeaker enclosures to amend some of these deficiencies. These baffles include multiple reed fingers that act as an internal tuning port to control the resonance of the air inside the loudspeaker cabinet. The result is often a smoother, deeper bass response than prior art ported enclosures.

Passive radiators have also been employed in a fluid-tight enclosure to improve the low frequency response of the speaker system and produce bass response similar to that of ported loudspeakers. Passive radiators eliminate noises at high levels, but lack the efficiency of ported systems. Small enclosures seldom accommodate passive radiators, which need a larger cross-section than the active bass radiator. It has been shown that augmenting the acoustic mass of air contained in a loudspeaker enclosure can produce bass quality in between that of loudspeaker ports or passive radiators. The acoustic lens utilizes multiple passive radiators and occasionally amplifies bass output. Previous methods nonetheless demand sophisticated construction methods. Typically the interior of the speaker enclosure is slightly damped because either type of bass loading fails to transform the back wave of the moving speaker cone into useful acoustic output with perfect efficiency.

### BRIEF SUMMARY OF THE INVENTION

In view of the above, it is an object of the present invention to provide a compact loudspeaker system with smaller low frequency speaker devices that provides a bass response comparable to a larger box with larger low frequency speaker devices. More particularly, it is an object of the present invention to provide a bass-reflex port that improves the bass response and output of a loudspeaker system. It is another object to provide a bass-reflex port that reduces the half-power response point of low frequency speaker devices. It is also an object to provide a bass-reflex port that preserves or increases the bandpass while amplifying the port output. Other objects and features of the invention will be in part apparent and in part pointed out hereinafter.

In accordance with the invention, a compact loudspeaker system is described. At least one low frequency speaker is mounted inside a sealed enclosure. A bass-reflex port is located inside the enclosure relative to the low frequency speaker to provide generally uniform acoustic loading.

The bass-reflex port is mounted on the enclosure in a somewhat flexible manner that provides additional bass reinforcement compared to prior art loudspeakers and reduces the half-power response point. Frequency response curve show that these improvements are obtained because the bass-reflex port allows the back wave from the moving cone of the bass speaker to exit the enclosure more efficiently through the port. This provides more useful acoustic energy from the back wave and amplified the port output. The bandpass, defined as the −3 dB points in the port response, of a conventional port and the present loudspeaker system may differ, with the loudspeaker system of the present invention having a broader bandpass. In summary, the loudspeaker system of the present invention has greater bass extension than a conventional port in the same size enclosure.

Other features of the invention include the provision of a loudspeaker system which will furnish a more closely linear response from low to medium frequencies dramatically reducing resonance peaks; improving bass transient response; reducing unnatural coloration in low frequencies by attenuating cabinet resonant output by directing the pressure build-up energy to be expended in useful sound radiation instead of producing spurious “box” resonances. Power handling is also improved. The present invention provides a loudspeaker system capable of generating a high volume output with a relatively flat response and good efficiencies through the low frequencies.

The invention summarized above comprises the constructions hereinafter described, the scope of the invention being indicated by the subjoined claims.

### BRIEF DESCRIPTION OF THE SEVERAL VIEWS OF THE DRAWING

In the accompanying drawings, in which one of various possible embodiments of the invention is illustrated, corresponding reference characters refer to corresponding parts throughout the several views of the drawings in which:

FIG. 1 is a cross-sectional view of a loudspeaker system including an enclosure, a low frequency speaker device and a bass-reflex port in accordance with the present invention;

FIG. 2 is an exploded perspective view of the loudspeaker system;

FIG. 3 is a front elevation on an enlarged scale of the bass-reflex port mounted in a wall of the enclosure;

FIG. 4 is a cross-sectional view on an enlarged scale taken along the line 4-4 in FIG. 1; and,

FIG. 5 is an exploded perspective view of the bass-reflex port detached from the enclosure.

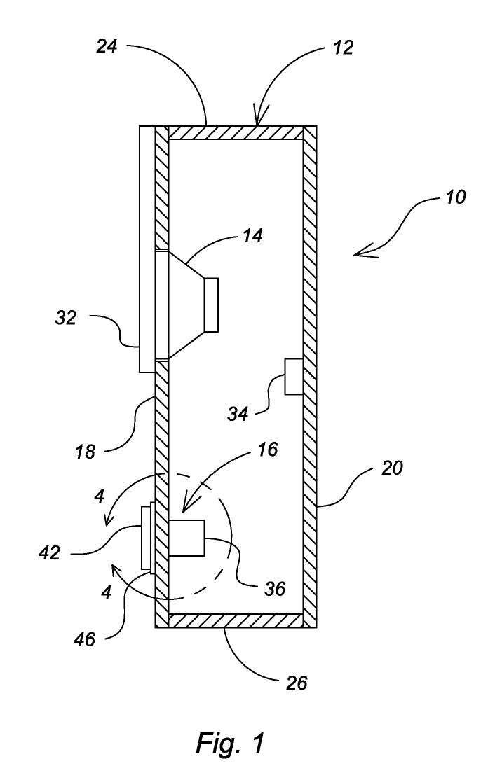

### DETAILED DESCRIPTION OF THE INVENTION

Referring to the drawings more particularly by reference character, reference numeral 10 refers to loudspeaker system including an enclosure 12 which accommodates a low frequency speaker device 14 and a bass-reflex port 16 which is autoaugmented as described below.

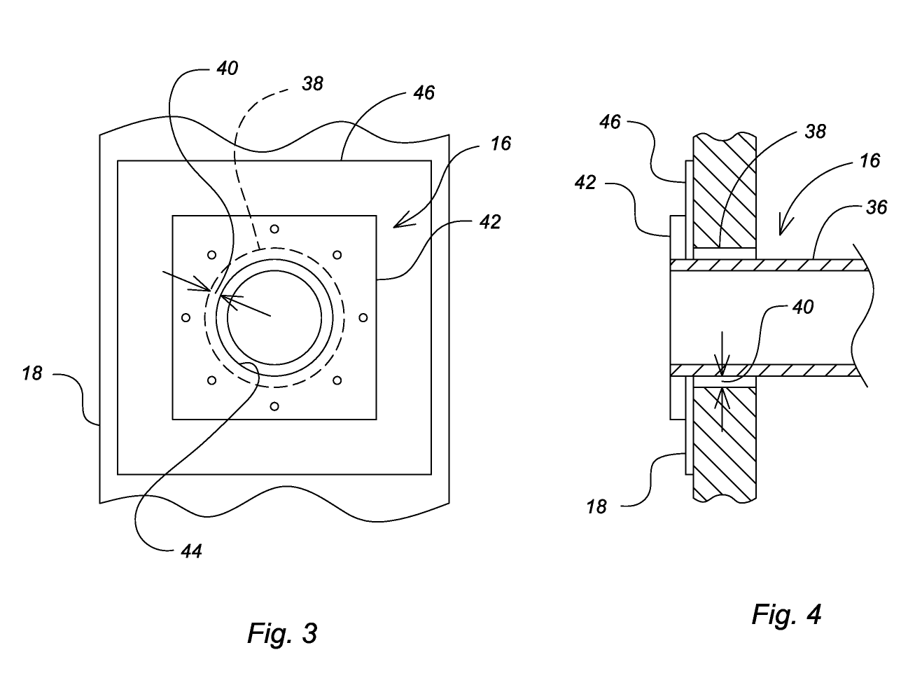

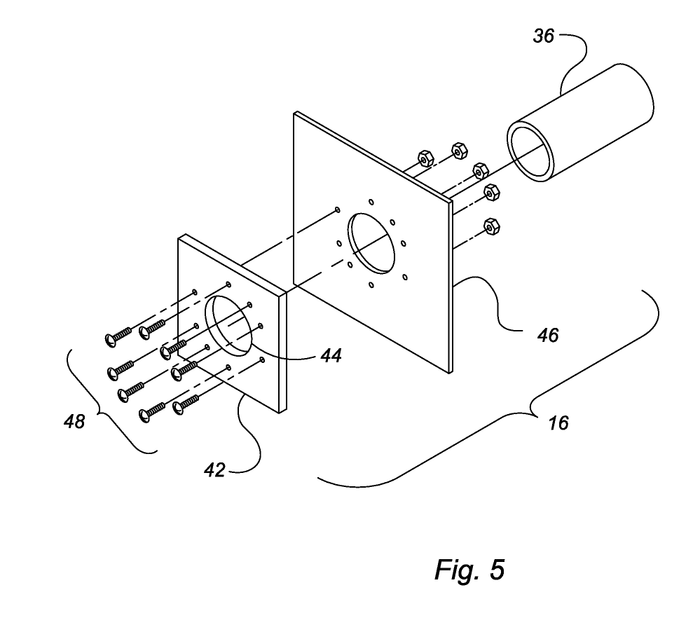

Enclosure 12 comprises an acoustical cavity and, as illustrated in FIG. 3, is typically formed as a wooden cabinet with front 18 and rear walls 20 interconnected with sidewalls 22 and top 24 and bottom 26 walls. Woods frequently used for enclosure 12 include plywood, particle board, medium density fiberboard (MDF) and laminated wood board. Among the many types of materials available, MDF, plywood or particle board are presently the best choice in terms of price, processability and acoustic characteristics. While enclosure 12 is illustrated as a rectangular or parallelpiped structure, it will be understood that enclosure 12 may have other shapes, e.g., tetrahedral, spherical or compound, which may be dictated more by aesthetics than function. Enclosure 12 may also be formed of other materials including metal, plastic or the like so long as it is air-tight and the wall in which low frequency speaker device 14 is mounted is comparatively rigid and vibration-free.

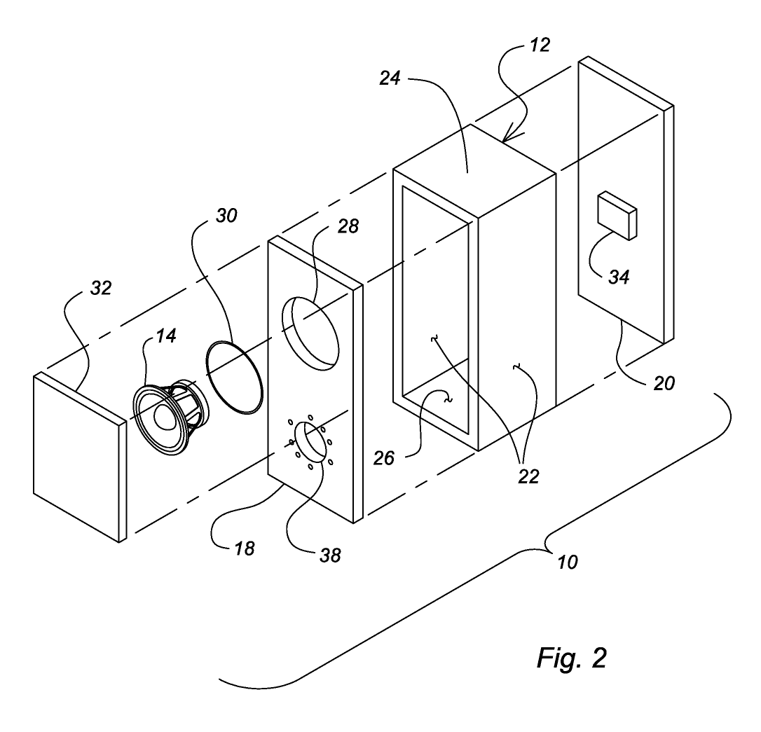

Front wall 18 has a plurality of speaker openings to receive low and midrange speakers and tweeters but for clarity of illustration only opening 28 for the low frequency speaker device 14 is shown in FIG. 2. The term low frequency speaker device 14 as used herein includes speakers resonant below about 200 Hz and thus includes sub-woofers, woofers and in some instances midrange speakers. The speakers, including low frequency speaker device 14, can be mounted to either the inner or outer surfaces of front wall 18 with appropriate screws, glue or other fasteners, with gaskets 30 applied as necessary. A speaker grill 32 is shown in FIGS. 2 and 3 for aesthetics. As illustrated grill 32 does not cover bass-reflex port 16, an optional arrangement. An assembly for crossover 34 is also depicted.

Bass-reflex port 16 includes a tubular body 36 open at one end to the inside volume of enclosure 12 and at an opposite end to the listening space. Tubular body 36 may be formed of suitable materials such as wood, plastic, rubber, cardboard or the like. Suitable woods for tubular body 36 include all those materials mentioned above for enclosure 12. Plastics such as polyvinylchloride may be preferred for cost and mechanical properties. While tubular body 36 is illustrated cylindrical and unperforated, it will be understood that tubular body 36 may have flared ends or a constricted mid-section as well as other shapes in cross-section such as star-shaped, oval and the like and be perforated.

The dimensions of tubular body 36 are selected to furnish suitable bass loading for low frequency speaker device 14. Numerous software programs and tables are available in the loudspeaker literature using the Thiele-Small parameters of the bass speaker. Enclosure 12 may also be selectively damped to modulate loading.

As illustrated in the drawings, an aperture 38 is provided in front wall 18 for mounting bass-reflex port 16. It will be understood, however, that bass-reflex port 16 may be mounted in any other wall of enclosure 12. Aperture 38 is slightly oversized such that tubular body 36 does not make hard contact with enclosure 12 when mounted therein. For example as shown in FIGS. 3 and 4, a spacing 40 of about ¼ inch may be provided around tubular body 36 in aperture 38. It will be understood that this measurement is illustrative for a tubular body 38 with an OD of 2 inches and is not limiting.

Tubular body 36 is suspended in aperture 38 by a flange 42. Flange 42 is larger than aperture 38 and includes an opening 44 in registry with the inner wall of tubular body 36. Tubular body 36 may be attached to flange 42 with fasteners, glue or may be fused or molded as an integral unit. Alternatively, flange 42 may include a collar into which tubular body 36 slips and is frictionally engaged. Flange 42 may be formed of the same classes of materials suitable for tubular body 36.

Flange 42 and tubular body 36 are mounted in an air-tight manner to front wall 18 with a dampening pad 46 interposed there between. Dampening pad 46 may be formed of a damping material. Such materials include elastomers such as rubber or plastics such as some polyurethanes. Sponge, profiled polymers (e.g., eggcrate foam), felt or sandwich materials like Dynamat which is felt embedded with lead with an adhesive backing may also be useful. Flange 42, dampening pad 46 and front wall 18 may be drilled for receipt of screws 48, rivets, Hurricane Nuts or other suitable fasteners. A coarse screen (not shown) that does not unduly restrict air flow may be provided over bass-reflex port 16 for aesthetics and to prevent the insertion of a foreign object.

In use, tubular body 36 is free to vibrate in aperture 38 while dampening pad 46 suppresses the transfer of vibrations from bass-reflex port 16 to enclosure 12. The result is that loudspeaker system 10 produces higher quality bass from a smaller enclosure 12 than was possible with the prior art. Other advantages include: Bass reflex port 16 is smaller and more cost-effective than an acoustic lens, which requires multiple passive radiators and significantly more intricate cabinet work. Bass-reflex port 16 is also more cost-effective and easier to tune reliably than base loading with a passive radiator. Bass-reflex port 16 is preferable over small enclosures with small drivers that use flared ports to load the front wave of the loudspeaker because those loudspeaker systems require elaborate and expensive cabinetry and extensive tuning. Bass-reflex port 16 is also preferable over small enclosures with flared ports because those enclosures can suffer port decoupling at high outputs and can be unwieldy because the port projects outward from the enclosure.

Like reed-loaded ported designs, bass-reflex port 16 broadens the frequency response of the external port and improves the transient response of a loudspeaker. On the other hand, bass-reflex port 16 is less expensive to build than reed-loaded ported designs which require intricate cabinetry and have high tuning demands. In addition, although reed-loaded ported design require relatively small enclosures and diminish the one-note quality found in the bass response of many ported designs, reed-loaded ported designs fail to provide sufficient bass amplification unlike bass-reflex port 16.

### Example

In one specific example, a Vifa 8″ woofer, #MG22WO09-08, was mounted in enclosure 12 having outer dimensions 22″(H)×12″(W)×9.5″(D). A polyvinylchloride tubular body 36 having an outside diameter of 2″ and a length of 5.3″ was mounted in aperture 38 as described above. It is estimated that bass-reflex port 16 reduced the half-power response point of low frequency speaker device 14 from 44 Hz as measured in an anechoic chamber. Improvements were obtained because the bass-reflex port 16 amplified (i.e., autoaugmented) the port output. Moreover, the tuning frequencies of a conventional and the autoaugmented port remained the same. Consequently, the bandpass, defined as the −3 dB points in port response, of the subject bass-reflex port 16 was broader than those of a conventional port.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What is claimed:

1. A loudspeaker system comprising an enclosure which accommodates a low frequency speaker device and a bass-reflex port,
said port being a tubular body, open at one end to the inside volume of the enclosure and open at the other end to a listening space, said tubular body suspended in an aperture in the enclosure by a flange such that the tubular port does not make hard contact with the enclosure and is free to vibrate on the flange, a dampening pad is provided between the flange and the exterior of the enclosure to suppress transfer of vibrations from the tubular body and flange to the enclosure
whereby the vibrations of the port provide a flatter frequency response over a broader frequency range thereby improving the bass response.

2. The loudspeaker system of claim 1 wherein the port has suitable dimensions to furnish sufficient bass loading for the low frequency speaker device.

3. The loudspeaker system of claim 2 wherein the enclosure includes a rigid front wall in which a speaker opening for the low frequency speaker device and the aperture for the bass-reflex port are provided.

4. The loudspeaker system of claim 2 wherein the tubular body is attached to the flange.

5. The loudspeaker system of claim 2 wherein the tubular body and flange are integrally formed.

6. The loudspeaker system of claim 1 wherein the enclosure is suitable damped.

7. A loudspeaker system comprising an enclosure which accommodates a low frequency speaker device and a bass-reflex port,
said enclosure formed as a wooden cabinet with front and rear walls interconnecting with sidewalls and top and bottom walls to form a rectangular, air-tight structure,
said low frequency speaker device mounted in a speaker opening in the front wall together with at least one other speaker,
said port being a tubular body, open at one end to the inside volume of the enclosure and open at the other end to a listening space, said tubular body suspended in an aperture in the front wall of the enclosure by a flange such that the tubular does not make hard contact with the enclosure and is free to vibrate on the flange, a dampening pad is provided between the flange and the exterior of the enclosure to suppress transfer of vibrations from the tubular body and flange to the enclosure
whereby the vibrations of the port extends the bass response and provides additional bass reinforcement compared to prior art ported loudspeakers.

8. The loudspeaker system of claim 7 wherein the tubular body and the flange are formed of plastic.

9. The loudspeaker system of claim 8 wherein the plastic is polyvinylchloride.

10. The loudspeaker system of claim 8 wherein the dampening pad is an elastomer.

12. The loudspeaker system of claim 8 wherein the dampening pad is formed of rubber.

13. The loudspeaker system of claim 8 wherein the dampening pad is formed of felt.

14. The loudspeaker system of claim 8 wherein the tubular body is attached to the flange.

15. The loud speaker system of claim 8 wherein the tubular body and flange are integrally formed.
